(19) United States
(12) Patent Application Publication
(10) Pub. No.: US 2002/0138982 A1
(43) Pub. Date: Oct. 3, 2002

(54) Method for attaching mounting features in die while forming aluminum heat exchanger tank

(75) Inventors: Gene G. Rhodes, Bellville, MI (US); Gregory A. Whitlow, Whitmore Lake, MI (US); Keith Edward Liederman, Brighton, MI (US); Wen Fei Yu, Ann Arbor, MI (US)

Correspondence Address: BRINKS HOFER GILSON & LIONE, P.O. BOX 10395, CHICAGO, IL, 60610, US

(73) Assignee: Visteon Global Technologies, Inc.

(21) Appl. No.: 09/823,584

(22) Filed: Mar. 30, 2001

(51) Int. Cl. B23P 15/26

(52) U.S. Cl. 29/890.054; 29/505; 29/890.03

(57) ABSTRACT

A method for attaching mounting features to an aluminum heat exchanger tank during its formation is provided. A mounting feature with at least one extension protruding from it is provided and a heat exchanger tank is formed with at least one opening defined in it, apart from fluid flow openings. The method includes the step of attaching the mounting feature to the tank such that the extensions are received within the openings in the tank and the extensions are deformed to secure the mounting feature in place.

### FIELD OF THE INVENTION

This invention relates generally to the field of automobile heat exchanger tanks. In particular, this invention relates to a method for attaching mounting features to an aluminum heat exchanger tank.

### DESCRIPTION OF THE RELATED ART

In today's automobiles, the heat exchanger tank is one of the most important elements of the engine system due to its central location in the automobile. Due to its central location, numerous other elements of the engine system are mounted to the heat exchanger tank at many different points. This requires mounting features on the outside of the heat exchanger tank to allow these connections to other parts of the engine system. These mounting features include nuts, clips, pins and any other necessary parts.

The preferred method for forming heat exchanger tanks with mounting features is through the process of injection molding. The mold is defined to form the necessary mounting features and the tank is molded to incorporate the mounting features. Any number of mounting features can be defined on a tank in this manner, but a new injection mold must be created if a different set of mounting features is needed. Furthermore, this method is only useful in the formation of heat exchanger tanks from resin or plastic, since the material must be injected into the mold in a fluid form and allowed to harden.

Another method for forming heat exchanger tanks with mounting features is described in U.S. Pat. No. 5,613,550. This method requires the formation of a box-shaped element on the outside of the heat exchanger tank. The shape of this element allows the placement of a nut or another type of mounting feature into the element. The mounting feature is held in place by the interaction between an engagement groove on the box-shaped element and a protrusion on the nut itself.

It is desirable to form heat exchanger tanks from aluminum. Unfortunately, since aluminum heat exchanger tanks are formed through a metal stamping process, it is not possible to use the same methods described above at a comparable cost. Extra steps are necessary and with these extra steps come a decrease in production efficiency and an increase in cost.

It is desirable to further increase the efficiency of the formation of aluminum heat exchanger tanks with mounting features attached.

### BRIEF SUMMARY OF THE INVENTION

In a preferred embodiment of the invention, a method for attaching mounting features to an aluminum heat exchanger tank during its formation is provided. A mounting feature with at least one extension protruding from it is provided and a heat exchanger tank is formed with at least one opening defined in it, apart from fluid flow openings. The method includes the step of attaching the mounting feature to the tank such that the extensions are received within the openings in the tank and the extensions are deformed to secure the mounting feature in place.

In an alternate embodiment of the invention, a mounting feature with at least one extension having a sharp end is provided and the sharp end on the extension pierces the side of a heat exchanger tank. The embodiment further includes the step of deforming the extension such that the mounting feature is secured in place.

In yet another embodiment of the invention, a mounting feature with at least one extension is provided and a heat exchanger tank is shaped with at least one indentation defined in its side. The extension of the mounting feature is received within the indentation on the side of the tank and the indentation is deformed around the extension to hold the mounting feature in place.

In yet another embodiment of the invention, a mounting feature with indentations defined in it is provided is aligned with a heat exchanger tank such that the side of the mounting feature having the indentations is pressed against the tank. The sides of the tank are deformed into the indentations to hold the mounting feature in place.

### BRIEF DESCRIPTION OF SEVERAL VIEWS OF THE DRAWINGS

FIG. 1 is a cross-section of an embodiment of a mounting feature of the invention with indentations defined in it for use in the method of the present invention;

FIG. 2A is a side view of an alternate embodiment of a mounting feature for use in the present invention;

FIG. 2B is a perspective view of an alternate embodiment of a mounting feature for use in the present invention;

FIG. 3 is a perspective view of an embodiment of the invention with a mounting feature lined up with holes in a heat exchanger tank;

FIG. 4 is a perspective view of the embodiment of FIG. 3, with the mounting feature in place on the heat exchanger tank;

FIG. 5 is a perspective view of the embodiment of FIG. 3, showing the extensions of the mounting feature on the inside of the heat exchanger tank;

FIG. 6 is a perspective view of the embodiment of FIG. 3, showing the deformed extensions of the mounting feature on the inside of the heat exchanger tank;

FIG. 7 is a top view of an embodiment of the invention showing a mounting feature lined up with indentations defined in a heat exchanger tank;

FIG. 8 is a top view of the embodiment of FIG. 7, with the mounting feature in place on the heat exchanger tank and the heat exchanger tank deformed around the extensions of the mounting feature; and

FIG. 9 is a top view of the mounting feature of FIG. 1 in place on a heat exchanger tank.

### DETAILED DESCRIPTION OF THE PREFERRED EMBODIMENTS OF THE INVENTION

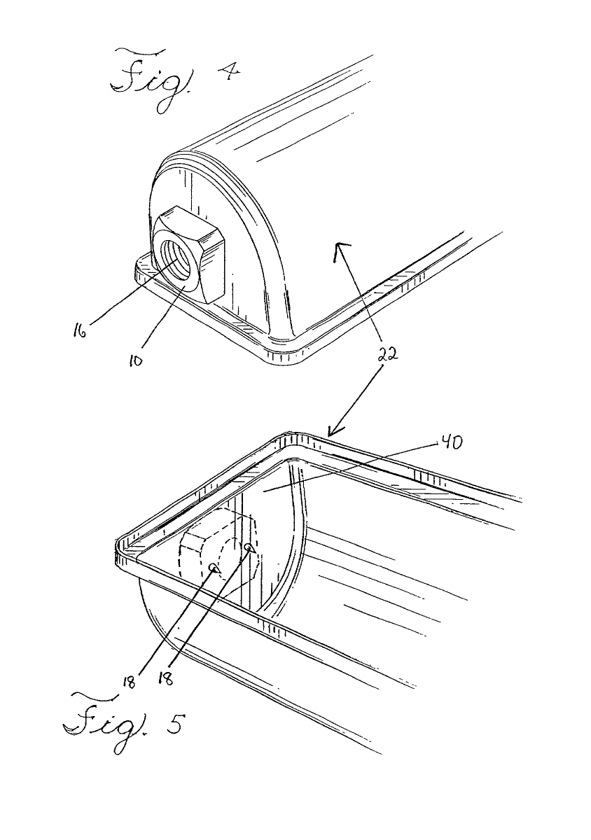

Referring in combination to FIGS. 2-6, an embodiment of the method is shown. FIGS. 2A and 2B show alternate embodiments of a mounting feature for use in the method. The mounting feature shown in FIGS. 2-6 is in the form of a nut 10. The nut 10 has a first side 12 and a second side 14 and a threaded round opening 16 preferably defined in the center of the nut 10. The nut 10 is preferably formed from a metal harder than aluminum. Other elements of the engine system (not shown) are fitted with a matching threaded extension that is inserted into the threaded opening 16 of the nut 10 to mount the element. On the second side 14 of the nut 10 two protrusions in the form of extensions 18 preferably projecting parallel to the axis of the opening 16 in the nut 10 are defined. In FIGS. 2A and 2B, two preferred embodiments of the extensions 18, 19 are shown. In the embodiment shown in FIG. 2A, the extensions 18 are preferably flat on their distal ends. In the other preferred embodiment shown in FIG. 2B, the extension 19 is in the form of a cylinder with a sharp end 21. The design of the extensions 18, 19 depends on the particular method and embodiment of the invention that is in use.

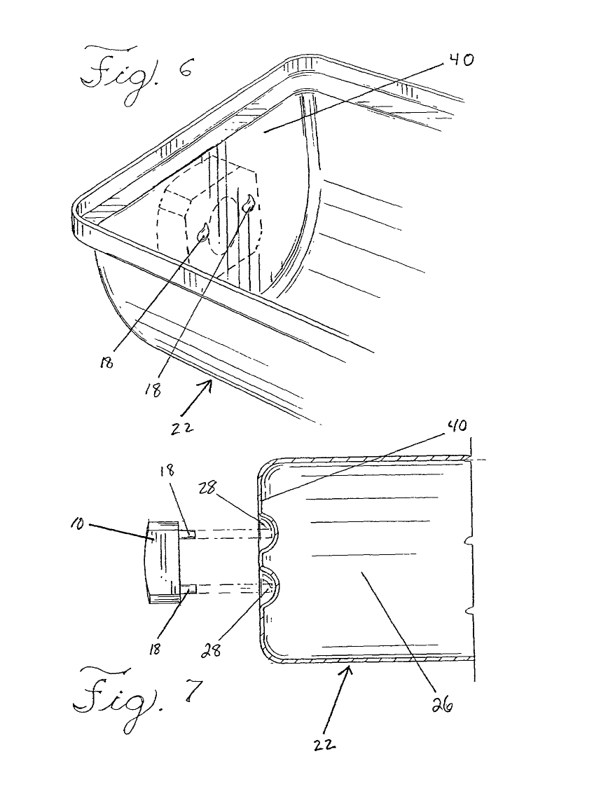

FIG. 3 shows structures utilized in the preferred embodiment of the method. An aluminum heat exchanger tank 22 is shaped in a stamping die from a roll of sheet aluminum in a progressive manner (not shown). In one embodiment of the method, using the embodiment of the nut 10 shown in FIG. 2A, two openings in the form of circular holes 24 are defined in the side of the tank 22 upon which the nut 10 is to be mounted. The holes 24 are preferably formed by die buttons that punch the holes 24 in the tank 22 during the formation of the tank 22 in the stamping die. The holes 24 can take any shape necessary to match the extensions 18 on the nut 10. A system of vibrating bowls (not shown) is utilized. The system consists of a main hopper and helix track running along the inside edge into a tube that leads into the placement of the mounting feature in the die. The vibrating motion of the bowl forces the mounting features up the helix track and into the tube. The vibrating bowl system allows a user to load the nuts 10 or other mounting features ahead of time, providing a completely automated process after loading the nuts 10 or other mounting features. The vibrating bowls feed the mounting features through tubes (not shown) into position such that the extensions 18 are in line with the holes 24 in the tank 22. The extensions 18 are received in the holes 24 in the tank 22, such that the extensions 18 protrude into the interior 26 of the tank 22 as shown in FIG. 5. A die button preferably deforms the extensions 18 in a manner so as to hold the nut 10 in place as shown in FIG. 6. The nut 10 is held in place in this manner until the tank 22 enters a brazing oven, which welds the nut 10 in place on the tank 22. The nut 10 will remain in place without brazing, however, the weld formed by brazing is much stronger and preferred since it prevents leakage. The final product of the method is shown in FIG. 4.

Another embodiment of the method utilizes the embodiment of the nut 10 shown in FIG. 2B. This embodiment has an extension 19 in the form of a cylinder having a sharp end 21. In this embodiment, it is not necessary to define holes 24 in the tank 22. Since aluminum is a relatively soft metal, and the nut 10 is preferably formed from a work-hardened machinable aluminum alloy, the sharp end 21 on the extension 19 is able to pierce the side of the tank 22. This piercing is made possible by pressure preferably applied by die buttons against the nut 10. Once the sharp end 21 pierces the side of the tank 22, the extension 19 protrudes into the interior 26 of the tank 22 in the same manner as described above and shown in FIG. 5 in relation to the extensions 18 of the embodiment shown in FIG. 2A. The extension 19 is then deformed to hold the nut 10 and the cut out slug in place. Alternatively, the slug is removed, providing another opening for fluid flow. The tank 22 and the attached nut 10 are then fed into a brazing oven to weld the nut 10 to the tank 22.

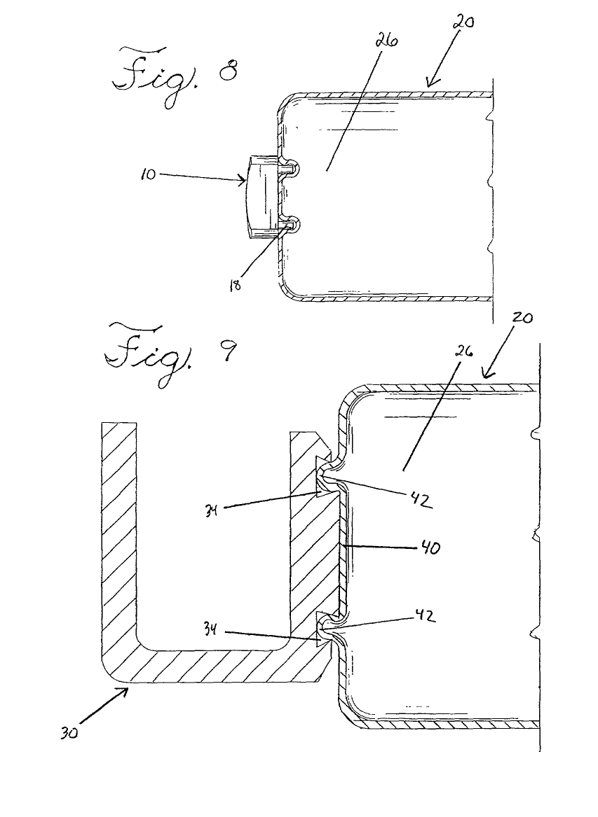

In an alternate embodiment of the method, neither holes 24 nor sharp ends 21 are utilized. FIGS. 7 and 8 show this alternate embodiment. A number of indentations 28 are defined in the tank 22. These indentations 28 are preferably of a size matching the thickness of the extensions 18 on the mounting feature, shown as a nut 10 in the Figures. The nut 10 is fed via vibrating bowls into the stamping die to line up with the indentations 28. Once the extensions 18 are in place in contact with the indentations 28, a die button preferably deforms the material of the side of the tank 22 around the extensions 18, as shown in FIG. 8. Pinching or pressing the side of the tank 22 against the extensions 18 of the nut 10 secures the nut 10 in place. This method has the added advantage of being more leak resistant than the previous embodiments of the method, since holes 24 are never formed in the side of the tank 22. Although brazing the mounting feature to the tank 22 alleviates some danger of leakage, it is preferable to avoid punching holes 24 in the tank 22 if possible. By deforming the tank 22 around the extensions 18, the nut 10 stays in place until brazing and the side of the tank 22 remains undamaged.

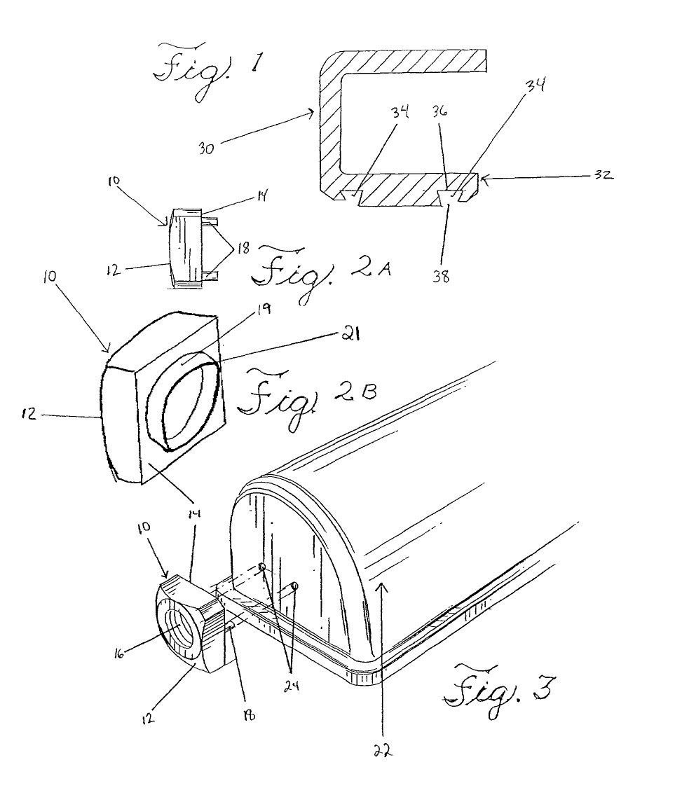

Another embodiment of the method is shown in FIGS. 1 and 9. A clip 30 is shown as the embodiment of the mounting feature, but a nut 10 could be used or any number of other mounting features. In this embodiment, a side 32 of the clip 30 has a number of indentations 34 defined thereon. These indentations 34 preferably have a first side 36 and a second, or open side 38. The indentations 34 are preferably trapezoidal-shaped in cross-section, and the open side 38 is preferably narrower than the first side 36, although other shapes, such as rectangular or rounded cross-sections, can be used. Preferably, the tank 22 is formed in a stamping die as in the other embodiments and the clip 30 is aligned such that side 32 of the clip 30 with the indentations 34 comes in contact with the side of the tank 22. Preferably, die buttons apply pressure to the interior side 40 of the tank 22 in a position adjacent to the indentations 34 in the clip 30. The pressure of the die buttons against the tank 22 deforms areas 42 of the tank 22 into the indentations 34 in the clip 30. Since the indentations 34 are narrower at the open side 38, the deformation of the areas 42 of the tank 22 into the indentations 34 allows the clip 30 to remain in place until the final welding process. As with the previous embodiment, the tank 22 is not pierced, and is therefore more resistant to leakage.

All of the embodiments of the present method have distinct advantages over the prior art methods. Using the present method, mounting features are mounted to a tank 22 at a faster and more efficient rate. There is no need to form a specific stamping die for each type of mounting feature, as is necessary in the prior art method of injection molding plastic heat exchanger tanks with mounting features in place. One stamping die can be used for any number of mounting features, the only feature that must be changed is the position of the vibrating bowls and tubes used to feed the mounting features into the stamping die and the position of the die buttons used to help the mounting feature pierce the side of the tank 22 and to deform either the tank 22 or the extensions 18, 19 of the mounting feature in order to hold the mounting feature in place until brazing.

This method also has an advantage over prior methods of forming heat exchanger tanks from aluminum. Prior art methods require the formation of an extra holding feature on the outside of the tank 22. This requires specific stamping dies to form the holding features. It also requires extra material and extra time to finish the heat exchanger tank. This method eliminates the need for extra holding features on the outside of the tank 22.

It should be noted that there could be a wide range of changes made to the present invention without departing from its scope. The mounting feature could take many forms other than the clip 30 and the nut 10 shown in the Figures. The mounting feature could also have any number of extensions 18 in place in any position. Any type of mounting feature could be staked in place using this method. The welding step is not necessary to the process, but it does increase the bond between the mounting feature and the tank 22. Other fixating and leak-preventing processes may be used instead, such as soldering, sealing or using an adhesive. The tank 22 could be formed from material other than aluminum if necessary. The mounting features can be in any position on the tank 22, and on the inside of the tank 22 as well if necessary. Thus, it is intended that the foregoing detailed description be regarded as illustrative rather than limiting and that it be understood that it is the following claims, including all equivalents, which are intended to define the scope of the invention.

What is claimed is:

1. A method for attaching mounting features to an aluminum heat exchanger tank during the forming of said tank, said method comprising the steps of:
providing at least one mounting feature defining at least one extension protruding therefrom;
forming a heat exchanger tank in a stamping die to define at least one opening in said heat exchanger tank apart from openings required for fluid flow;
attaching said at least one mounting feature onto said tank such that said at least one extension protruding from said at least one mounting feature is received within said at least one opening defined in said heat exchanger tank; and
deforming said at least one extension such that said mounting feature is secured in place on said heat exchanger tank.

2. The method of claim 1, further comprising the step of feeding said heat exchanger tank into a brazing oven and welding said at least one mounting feature in place on said heat exchanger tank.

3. The method of claim 2, wherein said mounting feature has a plurality of extensions defined thereon and said heat exchanger tank is stamped with openings for receiving said extensions.

4. The method of claim 3, wherein said step of feeding said at least one mounting feature into said stamping die is performed via a vibrating bowl system.

5. A method for attaching mounting features to an aluminum heat exchanger tank during the forming of said tank, said method comprising the steps of:
providing at least one mounting feature with at least one extension protruding from one side thereon, said at least one extension having a sharp end;
providing a heat exchanger tank;
attaching said at least one mounting feature to said tank such that said at least one extension protruding from said at least one mounting feature pierces said heat exchanger tank; and
deforming said extension such that said mounting feature is secured in place on said heat exchanger tank.

6. The method of claim 5, wherein a die applies pressure to said mounting feature to pierce said heat exchanger tank.

7. A method for attaching mounting features to an aluminum heat exchanger tank during the forming of said tank, said method comprising the steps of:
providing at least one mounting feature with at least one extension protruding from one side thereon;
shaping a heat exchanger tank within a stamping die and defining at least one indentation in said heat exchanger tank;
feeding said at least one mounting feature into said stamping die such that said at least one extension protruding from said at least one mounting feature is received within said at least one indentation in said heat exchanger tank; and
deforming said at least one indentation defined in said heat exchanger tank around said at least one extension such that said at least one extension is held in place by the material of said heat exchanger tank.

8. The method of claim 7, wherein a separate die applies pressure to the interior of said heat exchanger tank in order to deform said at least one indentation around said at least one extension.

9. A method for attaching mounting features to an aluminum heat exchanger tank during the forming of said tank, said method comprising the steps of:
providing at least one mounting feature with at least one indentation defined thereon;
providing a heat exchanger tank;
aligning said at least one mounting feature such that the side of said at least one mounting feature upon which said at least one indentation is defined is in contact with said heat exchanger tank; and
deforming said heat exchanger tank such that the material of said heat exchanger tank is pressed into said at least one indentation defined in said mounting feature.

10. The method of claim 9, wherein said at least one indentation defined in said at least one mounting feature has a first side and a second side and said second side is the open side.

11. The method of claim 10, wherein said second side of said at least one indentation is narrower than said first side of said at least one indentation.

12. The method of claim 11, wherein said at least one indentation has a generally trapezoidal shape.

13. The method of claim 12, wherein a die button applies pressure to said heat exchanger tank to deform said heat exchanger tank into said at least one indentation defined in said mounting feature.
